(19) United States
(12) Patent Application Publication
(10) Pub. No.: US 2010/0127969 A1
(43) Pub. Date: May 27, 2010

(54) Non-Contact Input Electronic Device and Method Thereof

(75) Inventor: Ching-Heng Changchien, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 12/582,879

(22) Filed: Oct. 21, 2009

(30) Foreign Application Priority Data
Nov. 25, 2008 (TW) 97145573

(51) Int. Cl. G09G 5/00

(52) U.S. Cl. 345/156

(57) ABSTRACT

A non-contact input electronic device and a method thereof are disclosed. The non-contact input electronic device includes a display module, sensors and a control module. A plurality of sensors are disposed around the display module, respectively, to sense a non-contact input motion. The control module is coupled to the sensors, and it senses a moving order of the non-contact input according to the sensors, generates an input command corresponding to the moving order and executes the input command.

### CROSS-REFERENCES TO RELATED APPLICATIONS

This non-provisional application claims priority under 35 U.S.C. §119(a) on Patent Application No. 97145573 filed in Taiwan, R.O.C. on Nov. 25, 2008, the entire contents of which are hereby incorporated by reference.

### BACKGROUND OF THE INVENTION

1. Field of the Invention

The invention relates to an input electronic device and an input method thereof and, more particularly, to a non-contact input electronic device and a non-contact input method thereof.

2. Description of the Related Art

With the progress of the science and technology, new types of electronic products are invented to replace the old frequently. Many electronic products have input devices to allow a user to input related commands, and the electronic products receive and execute the commands to output the corresponding results. Thus, the user may communicate with the electronic products.

The most common input devices are keyboards or various keys. The user may input commands via the keyboard or the keys to trigger the electronic products to perform corresponding functions. For example, in a mobile phone or a computer, a keyboard or keys are used to input commands.

Recently, many touch input methods not needing keyboards or keys are developed. Via a resistive or capacitive touch screen, the user may input commands with the cooperation of an application and a tool such as a finger or a stylus directly. The input method may allow the user to input commands more intuitively.

Besides the touch screen, recently, another new input method using motion sensors disposed on a digital portable device is developed to achieve the input function. For example, a built-in motion sensor is disposed in a mobile phone, and when the user plays a song with the mobile phone, he only needs to swing the mobile phone to change the played song. However, the swinging mode for inputting commands is not adapted to an electronic product such as a notebook computer or an electronic product having mechanisms.

In addition, using the input methods above, the user should contact the electronic products or the related elements (such as the stylus). If touching the electronic product is inconvenient to the user, he may fail to finish the input process smoothly.

### BRIEF SUMMARY OF THE INVENTION

The invention provides a non-contact input electronic device. The non-contact input electronic device includes a display module, a plurality of sensors and a control module. The sensors are disposed around the display module, respectively, to sense a non-contact input motion. The control module is coupled to the sensors, and it generates an input command according to a moving order of the non-contact input motion sensed by the sensors and executes the input command.

The invention also provides a non-contact input method adapted to an electronic device having a display module. The method includes the steps as follows. A plurality of sensors are disposed around the display module. The sensors sense a non-contact input motion. An input command is generated according to a moving order of the non-contact input motion sensed by the sensors. The input command is executed.

Via the device and method disclosed in the invention, when a user wants to input information, he does not need to contact the non-contact input electronic device directly.

Thus, even if touching the electronic device is inconvenient to the user (for example, the user's hands are dirty or greasy), the user also may input related commands easily according to the non-contact input electronic device of the invention.

These and other features, aspects and advantages of the present invention will become better understood with regard to the following description, appended claims, and accompanying drawings.

### BRIEF DESCRIPTION OF THE DRAWINGS

FIG. 1 is a block diagram showing a non-contact input device in an embodiment of the invention;

FIG. 2 is a schematic diagram showing a non-contact input electronic device in an embodiment of the invention;

FIG. 3A is a first schematic diagram showing the use of the non-contact input electronic device in an embodiment of the invention;

FIG. 3B is a second schematic diagram showing the use of the non-contact input electronic device in an embodiment of the invention;

FIG. 3C is a third schematic diagram showing the use of the non-contact input electronic device in an embodiment of the invention; and

FIG. 4 is a flow chart showing the non-contact input method.

### DETAILED DESCRIPTION OF THE EMBODIMENTS

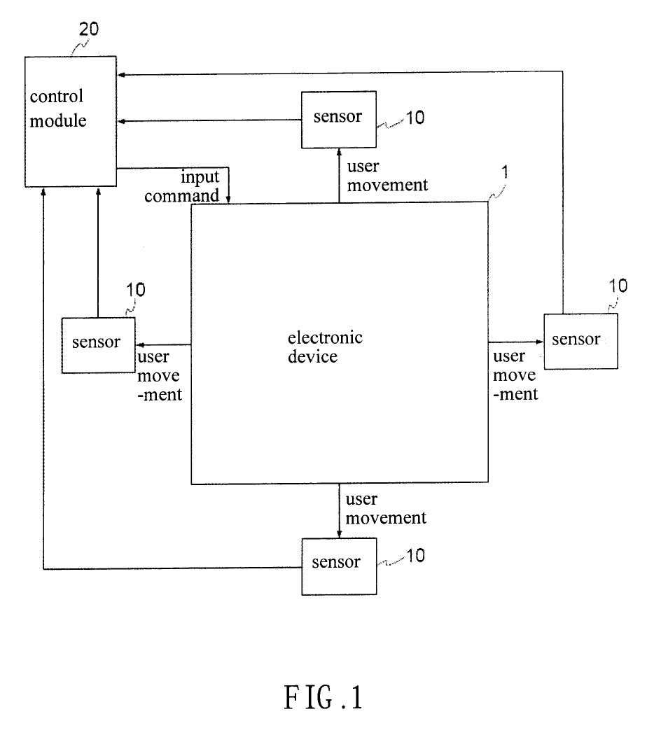

FIG. 1 is a block diagram showing a non-contact input electronic device in an embodiment of the invention. The non-contact input electronic device 1 includes sensors 10 and a control module 20.

The sensors 10 are disposed around the non-contact input electronic device 1, respectively, to sense the user's motion in a non-contact mode. The sensors 10 may be light sensors. Since the light sensors may generate sensing signals as long as light changes, the light changes when the user input a non-contact motion, and the motion is sensed to finish inputting related commands.

In other cases, the sensors 10 may be infrared sensors. Since a human body may emit heat naturally, the user's motion may be sensed via the change of the heat, and the command also may be input. Thus, different from the input method using a conventional resistive touch panel or capacitive touch panel, the non-contact input method does not ask the user to touch a touch panel to input commands.

The control module 20 is coupled to the sensors 10, and a moving order of the user's motion is sensed by the sensors 10 to generate an input command corresponding to the moving order. The control module 20 controls the non-contact input electronic device 1 to execute the input command. The input command corresponding to the moving order is illustrated in detail herein below.

As shown in FIG. 1, there are four sensors 10 in the embodiment, and they are disposed at a left side, a right side, an upper side and a lower side of the non-contact input electronic device 1. The number of the sensors 10 may be larger according to requirements, and it is not limited to be four.

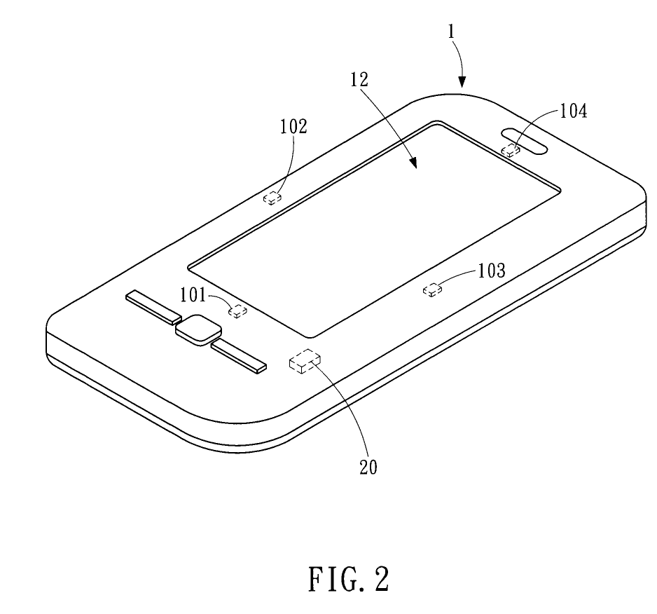

FIG. 2 is a schematic diagram showing the non-contact input electronic device in an embodiment of the invention. In the embodiment, the non-contact input electronic device 1 having the non-contact input function has a display module 12. In FIG. 2, the non-contact input electronic device 1 may be a handheld phone or a personal digital assistant, and it is not limited thereto.

In the embodiment, the sensors may be disposed around the display module 12, respectively, to sense the non-contact input motion made by the user when he inputs related commands. The number of the sensors may be four, and the sensors are a sensor 101, a sensor 102, a sensor 103 and a sensor 104 disposed at the left side, the upper side, the lower side and the right side of the display module 12, respectively. The non-contact input electronic device 1 may be polygon-shaped or even round. The number and positions of the sensors may be adjusted according to the shape of the non-contact input electronic device 1 or the display module 12, and it is not limited to form a quadrangle.

The control module 20 is coupled to the sensors 101 to 104, and the control module 20 may be a control chip disposed in the non-contact input electronic device 1. Since the sensors and the control module 20 are disposed in the non-contact input electronic device 1 to be electrically connected to a motherboard of the non-contact input electronic device 1, the sensors 101 to 104 and the control module 20 in FIG. 2 are denoted by dashed lines.

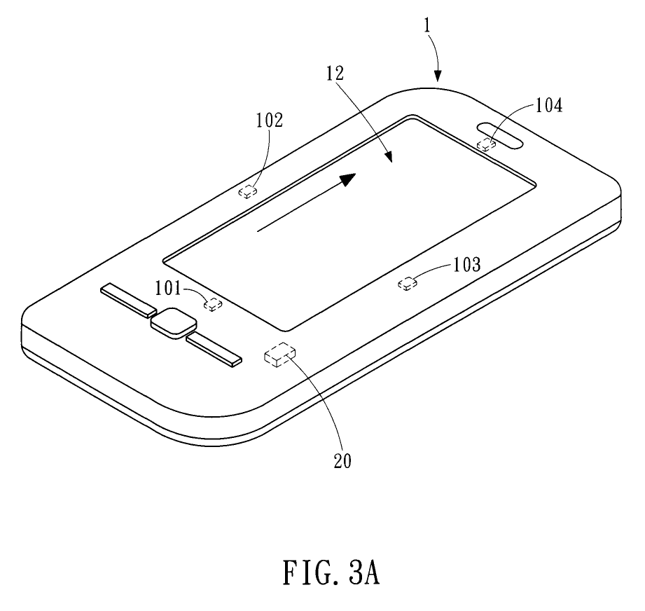

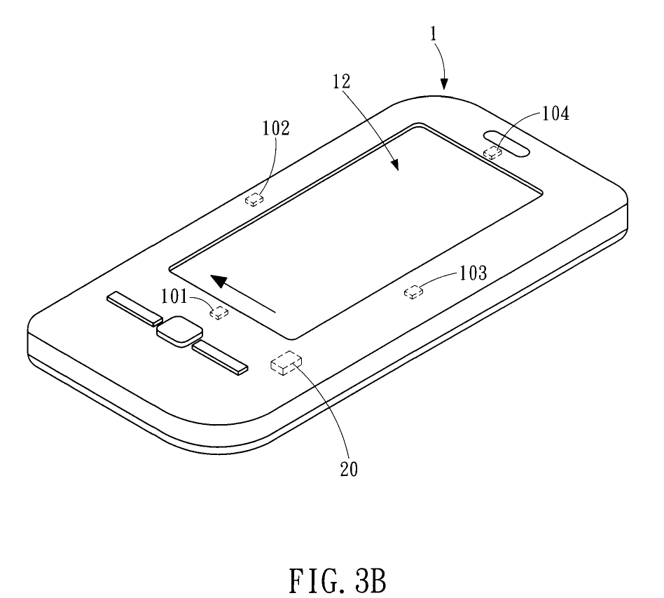

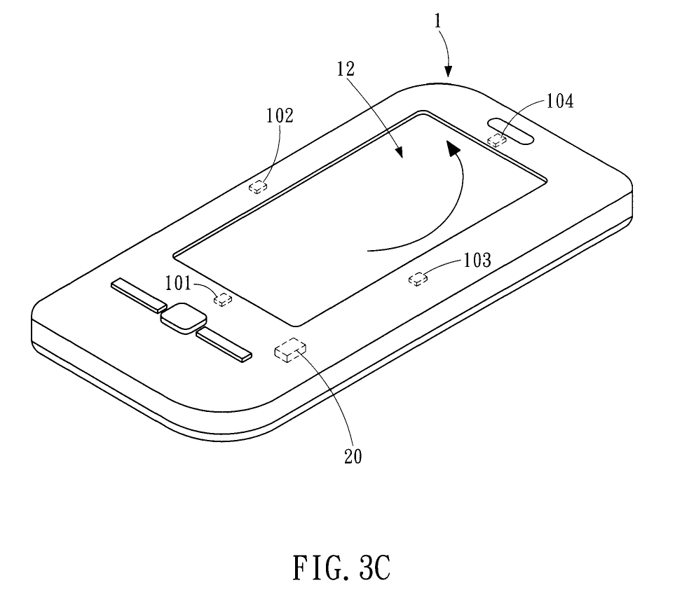

A plurality of sensors 101 to 104 sense the moving order of the non-contact input motion. Different input commands are generated via different moving orders. As shown in FIG. 3A to FIG. 3C, to take the light sensors as an example, if the light is blocked off, the light sensors may generate an interrupt signal to the control module 20, and the control module may determine the moving order of the user according to the time order in which each light sensor generates the interrupt signal.

FIG. 3A is a first schematic diagram showing the use of the non-contact input electronic device. In the embodiment, supposing that a user's hand moves from bottom to top, it sweeps the display module 12 without contacting the non-contact input electronic device 1. At that moment, to the four sensors 101 to 104 around the display module 12, the sensor 101 first senses the change of the light, and then the sensor 102 and 103 sense the change of the light at the same time. At last, the sensor 104 senses the change of light. Thus, the moving order of the user is detected to be bottom-to-top. The control module 20 may generate a corresponding input command and controls the non-contact input electronic device 1 to execute the input command.

As shown in FIG. 3A, the bottom-to-top arrow shows that the user's finger sweeps the display module 12 from bottom to top and finishes the input process. Supposing that the user utilizes the non-contact input electronic device 1 to use a specific application such as a music player, an image viewer or a power point application, the bottom-to-top moving order may make the non-contact input electronic device 1 execute the input command such as zooming in on the image or increasing the volume.

Correspondingly, when the user's hand moves from top to bottom, it sweeps the display module 12 without contacting the non-contact input electronic device 1. At that moment, to the four sensors 101 to 104 around the display module 12, the sensor 104 first senses the change of the light, and then the sensor 102 and 103 sense the change of the light at the same time. At last, the sensor 101 senses the change of light. Thus, the moving order of the user is detected to be top-to-bottom. According to the top-to-bottom moving order, the non-contact input electronic device 1 may execute the input command such as zooming out on the image or decreasing the volume.

FIG. 3B is a second schematic diagram showing the use of the non-contact input electronic device. Supposing that the user's hand moves right-to-left, it sweeps the display module 12 without contacting the non-contact input electronic device 1. At that moment, to the four sensors 101 to 104 around the display module 12, the sensor 103 first senses the change of the light, and then the sensors 101 and 104 sense the change of the light at the same time. At last, the sensor 102 senses the change of light. Thus, the moving order of the user is detected to be right-to-left. As shown in FIG. 3B, the right-to-left arrow shows that the user's finger sweeps the display module 12 from right to left and finishes the input process. At that moment, the non-contact input electronic device 1 may execute the input command such as page up or selecting music forward.

Correspondingly, when the user's hand moves from left to right, it sweeps the display module 12 without contacting the non-contact input electronic device 1. At that moment, to the four sensors 101 to 104 around the display module 12, the sensor 102 first senses the change of the light, and then the sensors 101 and 104 sense the change of the light at the same time. At last, the sensor 103 senses the change of light. Thus, the moving order of the user is detected to be left-to-right. According to the left-to-right moving order, the non-contact input electronic device 1 may execute the input command such as page down or selecting music backward.

FIG. 3C is a third schematic diagram showing the use of the non-contact input electronic device. Supposing that the user's hand moves counter-clockwise, it sweeps the display module 12 without contacting the non-contact input electronic device 1. At that moment, to the four sensors 101 to 104 around the display module 12, the sensor 103 first senses the change of the light, and then the sensor 104 senses the change of the light. Thus, the moving order of the user is detected to be counter-clockwise. As shown in FIG. 3C, the counter-clockwise arrow shows that the user's finger sweeps the display module 12 counter-clockwise and finishes the input process. At that moment, the non-contact input electronic device 1 may execute the input command such as rotating the image counter-clockwise or fast playing.

Correspondingly, when the user's hand moves clockwise, it sweeps the display module 12 without contacting the non-contact input electronic device 1. At that moment, to the four sensors 101 to 104 around the display module 12, the sensor 104 first senses the change of the light, and then the sensor 103 senses the change of the light. Thus, the moving order of the user is detected to be clockwise. According to the clockwise moving order, the non-contact input electronic device 1 may execute the input command such as rotating the image clockwise or playing backwards.

The display module 12 may show the result of executing the commands. For example, a next image, a next displayed song and related information are displayed.

FIG. 3A to FIG. 3C are just examples to show the moving orders and the corresponding input commands. The actual moving orders and the corresponding input commands may be designed according to the user's demands or preset by the system of the non-contact input electronic device, and they are not limited thereto.

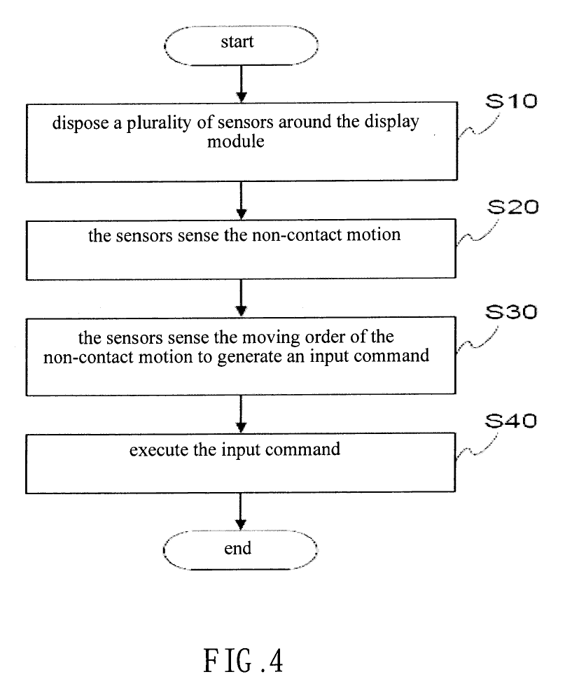

FIG. 4 is a flow chart showing the non-contact input method. The non-contact input electronic device having a display module. The method includes the steps as follows.

In step S10, a plurality of sensors are disposed around the display module. The sensors may be light sensors which may sense the non-contact input motion according to the change of the light. The sensors also may be infrared sensors which may sense non-contact input motion according to the change of the heat.

The method for disposing the sensors may include the step of disposing the sensors at the left side, the right side, the upper side and the lower side, respectively.

In step S20, the sensors sense the non-contact input motion.

In step S30, the sensors sense the moving order of the non-contact input motion and generate the input command.

In step S40, the input command is executed.

The moving order in the above has various aspects, and the following are just examples. When the moving order is left-to-right, the input command of page down or selecting music backward is executed. When the moving order is right-to-left, the input command of page up or selecting music forward is executed. When the moving order is bottom-to-top, the input command of zooming in on the image or increasing volume is executed. When the moving order is top-to-bottom, the input command of zooming out on the image or decreasing volume is executed. When the moving order is counter-clockwise, the input command of rotating the image counter-clockwise or fast playing is executed. When the moving order is clockwise, the input command of rotating the image clockwise or playing backward is executed.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A non-contact input electronic device, comprising:
a display module;
a plurality of sensors, disposed around the display module, respectively, for sensing a non-contact motion; and
a control module coupled to the sensors, generating an input command according to a moving order of the non-contact motion sensed by the sensors and executing the input command.

2. The non-contact input electronic device according to claim 1, wherein the sensors are light sensors and sense the non-contact motion according to the change of light.

3. The non-contact input electronic device according to claim 1, wherein the sensors are infrared sensors and sense the non-contact motion according to the change of heat.

4. The non-contact input electronic device according to claim 1, wherein the display module has a left side, a right side, an upper side and a lower side, and the sensors are disposed at the sides of the display module, respectively.

5. The non-contact input electronic device according to claim 1, wherein the moving order is left-to-right, and the input command is page down or selecting music backward.

6. The non-contact input electronic device according to claim 1, wherein the moving order is right-to-left, and the input command is page up or selecting music forward.

7. The non-contact input electronic device according to claim 1, wherein the moving order is bottom-to-top, and the input command is zooming in on an image or increasing volume.

8. The non-contact input electronic device according to claim 1, wherein the moving order is top-to-bottom, and the input command is zooming out on the image or decreasing the volume.

9. The non-contact input electronic device according to claim 1, wherein the moving order is counter-clockwise, and the input command is rotating the image counter-clockwise or fast playing.

10. The non-contact input electronic device according to claim 1, wherein the moving order is clockwise, and the input command is rotating the image clockwise or playing backward.

11. A non-contact input method adapted to an electronic device having a display module, the method comprising the steps of:
setting a plurality of sensors around the display module;
sensing a non-contact motion by the sensors;
sensing a moving order of the non-contact motion by the sensors to generate an input command; and
executing the input command.

12. The non-contact input method according to claim 11, wherein the sensors are light sensors and sense the non-contact motion according to the change of light.

13. The non-contact input method according to claim 11, wherein the sensors are infrared sensors and sense the non-contact input motion according to the change of heat.

14. The non-contact input method according to claim 11, wherein the step of disposing the sensors around the display module further comprises the steps of:
disposing the sensors at a left side, a right side, an upper side and a lower side of the display module, respectively.

15. The non-contact input method according to claim 11, further comprising the step of:
executing the input command of page down or selecting music backward when the moving order is left-to-right.

16. The non-contact input method according to claim 11, further comprising the step of:
executing the input command of page up or selecting music forward when the moving order is right-to-left.

17. The non-contact input method according to claim 11, further comprising the step of:
executing the input command of zooming in on an image or increasing volume when the moving order is bottom-to-top.

18. The non-contact input method according to claim 11, further comprising the step of:
executing the input command of zooming out on the image or decreasing the volume when the moving order is top-to-bottom.

19. The non-contact input method according to claim 11, further comprising the step of:
executing the input command of rotating the image counter-clockwise or fast playing when the moving order is counter-clockwise.

20. The non-contact input method according to claim 11, further comprising the step of:
executing the input commands of rotating the image clockwise or playing backwards when the moving order is clockwise.
